(19) United States
(12) Patent Application Publication
(10) Pub. No.: US 2026/0147220 A1
(43) Pub. Date: May 28, 2026

(54) POLARIZING BEAM MANIPULATION BACKGROUND

(71) Applicant: Applied Materials Israel Ltd., Rehovot (IL)

(72) Inventors: Roman Naidis, Rehovot (IL); Yinnon Glickman, Maale Hahamisha (IL); Yechiel Kapoano, Omer (IL); Menachem Lapid, Rehovot (IL)

(73) Assignee: Applied Materials Israel Ltd., Rehovot (IL)

(21) Appl. No.: 18/956,613

(22) Filed: Nov. 22, 2024

(51) Int. Cl. G02B 27/28; G02B 27/09

(52) U.S. Cl. CPC G02B 27/283; G02B 27/0955

(57) ABSTRACT

A polarizing beam manipulation unit, that includes: (i) a polarizing beam splitter that exhibits polarization extinction ratios that are based on angles of impingement of rays of radiation; and (ii) a telecentric lens that precedes the polarization beam splitter and is configured to: (a) receive a non-collimated input beam that comprises rays of different angles of impingement, and (b) convert the non-collimated input beam to a collimated input beam that comprises rays that are parallel to each other when impinging on the polarization beam splitter.

### BACKGROUND OF THE INVENTION

A polarizing beam splitter is configured to split an input light beam into a reflected first-polarized beam and a transmitted second-polarized beam.

A polarization extinction ratio is a ratio between the reflected first-polarized beam and the transmitted second-polarized beam.

It has been found that the polarization extinction ratio significantly varies (for example by a factor that exceeds ten) across a field of view segment of a longitudinal axis of the polarizing beam splitter. The field of view segment corresponds to a spot formed by the input light beam on the polarizing beam splitter.

There is a growing need to improve the uniformity of the polarization extinction ratio across the field of view segment.

### BRIEF SUMMARY OF THE INVENTION

There is provided a polarizing beam manipulation unit that includes (a) a polarizing beam splitter that exhibits polarization extinction ratios that are based on angles of impingement of rays of radiation; and (b) a telecentric lens that precedes the polarization beam splitter and is configured to (a) receive a non-collimated input beam that comprises rays of different angles of impingement, and (b) convert the non-collimated input beam to a collimated input beam that comprises rays that are parallel to each other when impinging on the polarization beam splitter.

There is provided a method for polarization based beam manipulation, the method comprises: (a) receiving, by a telecentric lens, a non-collimated input beam that comprises rays of different angles of impingement; (b) converting, by the telecentric lens, the non-collimated input beam to a collimated input beam that comprises rays that are parallel to each other when impinging on a polarization beam splitter that exhibits polarization extinction ratios that are based on angles of impingement of rays of radiation; and (c) optically processing the collimated input beam by the polarization beam splitter.

### BRIEF DESCRIPTION OF THE DRAWINGS

The subject matter regarded as the embodiment is particularly pointed out and distinctly claimed in the concluding portion of the specification. The embodiment, however, both as to organization and method of operation, together with specimen s, features, and advantages thereof, may best be understood by reference to the following detailed description when read with the accompanying drawings in which:

FIG. 1 illustrates an example of a polarizing beam manipulation unit;

FIG. 2 illustrates an example of the polarization extinction ratios along a field of view segment along a longitudinal axis of the polarizing beam splitter without a telecentric lens and with the suggested polarizing beam manipulation unit;

FIG. 3 illustrates an example of a system; and

FIG. 4 illustrates an example a method.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

There is provided a solution for reducing the differences between polarization extinction ratios, which enables to use polarization properties control during microscopy and especially during optical inspection of patterned samples, such as patterned wafers.

According to an embodiment, the polarization properties control involves at least one of controlling a polarization of light transmitted towards a sample or controlling a polarization of light reflected from the sample.

The polarization control may involve using a polarizing beam splitter. Additionally, or alternatively—the polarization properties control is executed by one or more other polarization control elements located in the illumination channel and, additionally or alternatively, in the collection channel.

According to an embodiment, the polarization properties control is used to reduce image background (for example by blocking reflected beam polarization components that are reflected by a pattern) and to enhance a signal from a specific region of the wafer by selecting polarization state which optimally penetrates the wafer pattern.

According to an embodiment, the blocking is executed by the polarizing beam splitter that will not pass to the collection channel, the reflected beam polarization components that are reflected by a pattern—while passing to the collection channel reflected beam polarization components that resulted from a penetration of the illumination beam in the pattern.

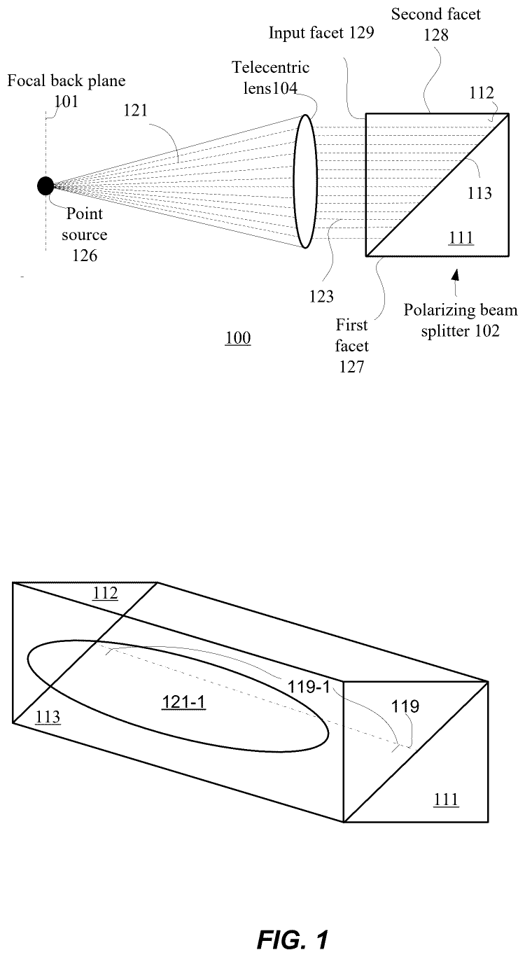

FIG. 1 illustrates an example of a polarizing beam manipulation unit 100 that includes (i) a polarizing beam splitter 102 that exhibits polarization extinction ratios that are based on angles of impingement of rays of radiation, and (ii) a telecentric lens 104 that precedes the polarization beam splitter and is configured to (a) receive a non-collimated input beam 121 that includes rays of different angles of impingement, and (b) convert the non-collimated input beam to a collimated input beam 123 that includes rays that are parallel to each other when impinging on the polarization beam splitter.

FIG. 1 also illustrates the longitudinal axis 119 of the polarizing beam splitter 102, spot 121-1 formed by the collimated input beam 123 on an input facet 129 of the collimated input beam 123, and a field of view segment 119-1 of the polarizing beam splitter along the longitudinal axis. The polarizing beam splitter also includes a first facet 127 and a second facet 128.

The parallel rays experience substantially the same polarization extinction ratio, whereas substantially the same may tolerate difference below a threshold - for example a difference of 10-50 precent, or 15-200 percent, or 20-450 percent, and the like.

According to an embodiment, and assuming that a ray at a center of a field of view segment of the polarizing beam splitter is normal to the polarizing beam splitter, the polarizing beam will provide (at the absence of the telecentric lens) a much higher polarization extinction ratio to the ray at the center of the field, in comparison to ray the impinged away from the center of the field of view segment.

According to an embodiment, the telecentric lens 104 has a back focal plane 101 that coincided with a point source 126 of the non-collimated input beam 121.

According to an embodiment, the telecentric lens improves a uniformity of the polarization extinction ratio across a field of view segment of a longitudinal axis of the polarizing beam splitter by factor of at least ten, or by factor of at least twenty, or by a factor of at least thirty, or by factor of at least fifty, or by factor of at least one hundred.

For example—while at an absence of the telecentric lens the highest polarization extinction ratio exceeded the lowest polarization extinction ratio by more than one hundred, the suggested polarizing beam manipulation unit exhibits a highest polarization extinction ratio that exceeded the lowest polarization extinction ratio by less than ten.

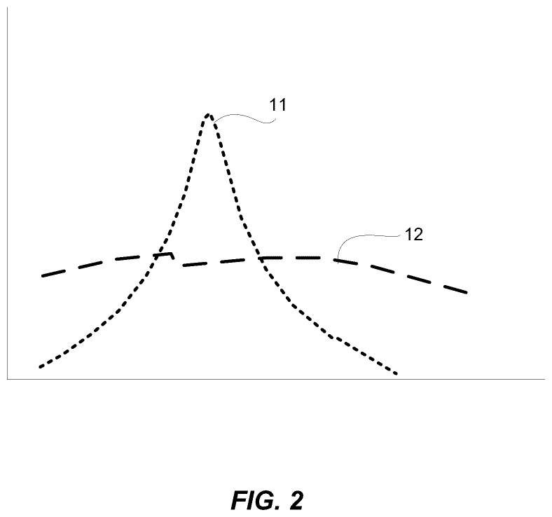

FIG. 2 illustrates an example of the polarization extinction ratios along a field of view segment along a longitudinal axis of the polarizing beam splitter without the telecentric lens (graph 11) and with the suggested polarizing beam manipulation unit (graph 12). The X-axis represents points along the field of view segment and the Y-axis represents the polarization extinction ratios—in a logarithmic scale.

According to an embodiment, and as illustrates in FIG. 1, the polarizing beam splitter 102 is a cube that includes a first right angle prism 111 and a second right angle prism 112.

According to an embodiment, a hypotenuse surface 113 of the first right angle prism is coated by a polarizing coating. According to an embodiment, a hypotenuse surface of the second right angle prism is coated by a polarizing coating.

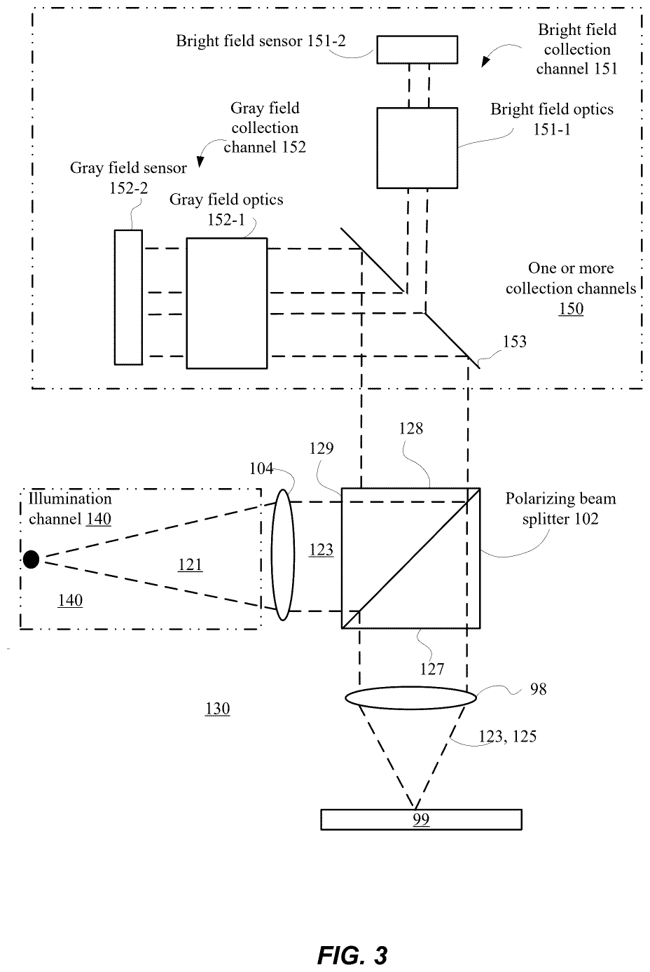

FIG. 3 illustrates an example of a system 130 that includes an illumination channel 140, one or more collection channels 150 and the polarizing beam manipulation unit 100. The illumination channel 140, and the one or more collection channel 150 share the polarizing beam splitter 102 and objective lens 131.

According to an embodiment, illumination channel 140 directs the non-collimated input beam 121 to the telecentric lens that provides the collimated input beam 123 (which is of a first polarization) to the polarizing beam splitter 102. The polarizing beam splitter 102 is configured to: (i) reflect the collimated input beam 123 towards a first facet 127 of the polarizing beam splitter, (ii) receive, at the first facet 127, a reflected beam 125 of a second polarization that is orthogonal to the first polarization, and (iii) direct towards a second facet 128 of the polarization beam splitter the reflected beam 125. The collimated input beam 123 passes through an input facet 129.

According to an embodiment, the second facet is opposite to the first facet, and the input facet is perpendicular to the first facet.

FIG. 3 illustrates the one or more collection channels 150 as including a bright field collection channel 151 (including bright field collection channel optics 151-1 and bright field sensor 151-2) and a gray field collection channel 152 (including gray field collection channel optics 152-1 and gray field sensor 152-2) that share a second beam splitter 153—such as an apertured mirror that performs a spatial based (rather angular based) splitting.

There may be any number of collection channels (one or more).

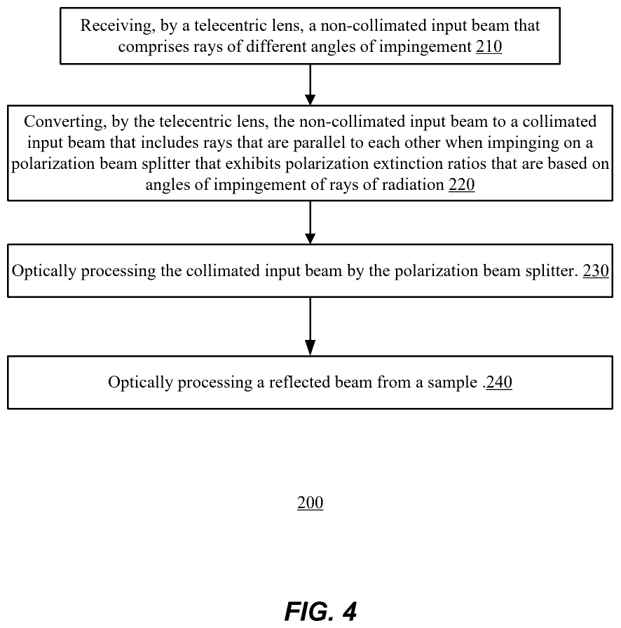

FIG. 4 illustrates an example of method 200 for polarization based beam manipulation.

According to an embodiment, method 200 is limited to beam splitting.

According to an embodiment, the method 200 includes more than just beam splitting.

According to an embodiment, method 200 includes:
a. Step 210 of receiving, by a telecentric lens, a non-collimated input beam that comprises rays of different angles of impingement.
b. Step 220 of converting, by the telecentric lens, the non-collimated input beam to a collimated input beam that comprises rays that are parallel to each other when impinging on a polarization beam splitter that exhibits polarization extinction ratios that are based on angles of impingement of rays of radiation.
c. Step 230 of optically processing the collimated input beam by the polarization beam splitter. According to an embodiment the processing includes directing the collimated input beam (or certain polarization components of the collimated input beam) towards (via an objective lens) a sample.
d. Step 240 of optically processing a reflected beam from a sample. According to an embodiment the processing includes directing the reflected beam (or certain polarization components of the reflected beam) towards at least one collection channel.

According to an embodiment, the telecentric lens has a back focal plane that coincided with a point source of the non-collimated input beam.

According to an embodiment, step 220 includes improving a uniformity of the polarization extinction ratio across a field of view segment of a longitudinal axis of the polarizing beam splitter by factor of at least ten.

According to an embodiment, the polarizing beam splitter is a cube that includes a first right angle prism and a second right angle prism.

According to an embodiment, a hypotenuse surface of the first right angle prism is coated by a polarizing coating.

According to an embodiment, the collimated input beam is of a first polarization, wherein the optical processing of step 230 and step 240 includes:
a. Reflecting the collimated input beam towards a first facet of the polarizing beam splitter.
b. Receiving, at the first facet, a reflected beam of a second polarization that is orthogonal to the first polarization
c. Directing towards a second facet of the polarization beam splitter the reflected beam.

According to an embodiment, the second facet is opposite to the first facet, wherein the collimated input beam is received by a third facet that is perpendicular to the first facet.

In the foregoing detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using optical components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

Any reference in the specification to a method should be applied mutatis mutandis to a system capable of executing the method.

Any reference in the specification to a system should be applied mutatis mutandis to a method that may be executed by the system.

The term “and/or” means additionally or alternatively. For example, A and/or B means only A, or only B or A and B.

In the foregoing description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

In the foregoing specification, the embodiments of the disclosure have been described with reference to specific examples of embodiments. It will, however, be evident that various modifications and changes may be made therein without departing from the broader spirit and scope of the appended claims.

Any reference to the term “comprising” or “having” or “including” should be applied mutatis mutandis to “consisting of” and/or should be applied mutatis mutandis to “consisting essentially of.”

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments have been illustrated and described herein, many modifications, substitutions, changes, and equivalents will now occur to those of ordinary skill in the art. It is, therefore, to be understood that the appended claims are intended to cover all such modifications and changes as fall within the true spirit of the embodiment.

What is claimed is:

1. A polarizing beam manipulation unit comprising:
a polarizing beam splitter that exhibits polarization extinction ratios that are based on angles of impingement of rays of radiation; and
a telecentric lens that precedes the polarization beam splitter and is configured to:
(a) receive a non-collimated input beam that comprises rays of different angles of impingement, and (b) convert the non-collimated input beam to a collimated input beam that comprises rays that are parallel to each other when impinging on the polarization beam splitter.

2. The polarizing beam manipulation unit according to claim 1, wherein the telecentric lens has a back focal plane that coincides with a point source of the non-collimated input beam.

3. The polarizing beam manipulation unit according to claim 1, wherein the telecentric lens improves a uniformity of the polarization extinction ratio across a field of view segment of a longitudinal axis of the polarizing beam splitter by factor of at least ten.

4. The polarizing beam manipulation unit according to claim 1, wherein the polarizing beam splitter is a cube comprising a first right angle prism and a second right angle prism.

5. The polarizing beam manipulation unit according to claim 4, wherein a hypotenuse surface of the first right angle prism is coated by a polarizing coating.

6. The polarizing beam manipulation unit according to claim 1, wherein the collimated input beam is of a first polarization, wherein the polarizing beam splitter is configured to: (i) reflect the collimated input beam towards a first facet of the polarizing beam splitter, (ii) receive, at the first facet, a reflected beam of a second polarization that is orthogonal to the first polarization, and (iii) direct the reflected beam towards a second facet of the polarization beam splitter.

7. The polarizing beam manipulation unit according to claim 6, wherein the second facet is opposite to the first facet, and wherein the collimated input beam is received by a third facet that is perpendicular to the first facet.

8. A method for polarization based beam manipulation, the method comprising:
receiving, by a telecentric lens, a non-collimated input beam that comprises rays of different angles of impingement;
converting, by the telecentric lens, the non-collimated input beam to a collimated input beam that comprises rays that are parallel to each other when impinging on a polarization beam splitter that exhibits polarization extinction ratios that are based on angles of impingement of rays of radiation; and
optically processing the collimated input beam by the polarization beam splitter.

9. The method according to claim 8, wherein the telecentric lens has a back focal plane that coincides with a point source of the non-collimated input beam.

10. The method according to claim 8, wherein the converting comprises improving a uniformity of the polarization extinction ratio across a field of view segment of a longitudinal axis of the polarizing beam splitter by factor of at least ten.

11. The method according to claim 8, wherein the polarizing beam splitter is a cube comprising a first right angle prism and a second right angle prism.

12. The method according to claim 11, wherein a hypotenuse surface of the first right angle prism is coated by a polarizing coating.

13. The method according to claim 8, wherein the collimated input beam is of a first polarization, and wherein the optically processing comprises: (i) reflecting the collimated input beam towards a first facet of the polarizing beam splitter, (ii) receiving, at the first facet, a reflected beam of a second polarization that is orthogonal to the first polarization, and (iii) directing the reflected beam towards a second facet of the polarization beam splitter.

14. The method according to claim 13, wherein the second facet is opposite to the first facet, and wherein the collimated input beam is received by a third facet that is perpendicular to the first facet.
